(19) United States
(12) Patent Application Publication
(10) Pub. No.: US 2007/0022275 A1
(43) Pub. Date: Jan. 25, 2007

(54) Processor cluster implementing conditional instruction skip

(75) Inventor: Jonathan Sweedler, Los Gatos, CA (US)

Correspondence Address: MARGER JOHNSON & MCCOLLOM, P.C., 210 SW MORRISON STREET, SUITE 400, PORTLAND, OR, 97204, US

(73) Assignee: Mistletoe Technologies, Inc., Cupertino, CA (US)

(21) Appl. No.: 11/189,140

(22) Filed: Jul. 25, 2005

(51) Int. Cl. G06F 9/44

(52) U.S. Cl. 712/226

(57) ABSTRACT

A system and method include identifying a conditional skip instruction, determining when a conditional skip instruction is satisfied according to a result of an associated compare function, and skipping a fixed-number of the instructions defined by the conditional skip instruction when the conditional skip function is satisfied.

### FIELD OF THE INVENTION

This invention relates generally to data processors, and more specifically to a system and method for implementing a conditional instruction skip.

### BACKGROUND OF THE INVENTION

In the data processing field, a processor executes instructions within sequential memory locations unless one of the instructions directs the processor to jump to a different non-sequential memory location. The processor then continues to sequentially execute instructions at the new non-sequential memory location until another instruction prompts a jump. A jump instruction is typically used when performing an unconditional jump to a non-sequential memory location, while a conditional branch instruction, as its name suggests, is used to jump to the non-sequential memory location upon satisfaction of a predicate condition.

An example operation of a conditional branch instruction is shown in FIG. 1. The assembly instructions shown in FIG. 1 implement the following if-statement:
if (A>B)
A=A+2;
Referring to FIG. 1, a memory 100 includes at least 4 address locations $0-$3 to be sequentially executed. Execution begins at address location $0 with a compare (cmp) instruction. The cmp instruction, when executed, compares two data values, A and B, and sets one or more bits in a condition register to indicate the result of the comparison, e.g., whether A>B, A<B, or A=B. Execution then continues to address location $1 where a conditional branch (brie) instruction jumps to address location $3 when the result of the previous comparison indicates data value A is less than or equal to data value B. When the condition is not satisfied, e.g., A is greater than B, execution continues to address location $2 where an addition (add) instruction adds 2 to data value A. The sequential execution then reaches address location $3 where the next instruction is awaiting execution.

Modern microprocessors use a technique called pipelining whereby the processing of an instruction is broken down into subtasks. These subtasks are all performed in parallel for different instructions and this is called a pipeline. Jumps and branches cause a break in the pipeline and so they lose time while some of the stages of processing sit empty. Some processors use a technique called branch prediction in order to ameliorate the performance impact of these pipeline breaks. However, this hardware does not predict perfectly and it can be large.

Although very powerful, conditional branch instructions are also time-consuming and inefficient due to the pipeline stalls. Thus, in high speed applications, the advantages of conditional branch instructions may be negated by the additional processing latency.

### DESCRIPTION OF THE DRAWINGS

The invention may be best understood by reading the disclosure with reference to the drawings, wherein:

FIG. 1 shows an example operation of a branch instruction;

FIG. 2 illustrates, in block form, a processing system useful with embodiments of the present invention;

FIG. 3 shows an example flow chart illustrating embodiments of a conditional skip instruction useful with embodiments of the present invention;

FIG. 4 shows an example operation of a conditional skip instruction useful with embodiments of the present invention; and

FIG. 5 illustrates, in block form, a reconfigurable semantic processor useful with embodiments of the present invention.

### DETAILED DESCRIPTION

In the data processing field, conditional branch functionality is very powerful, yet the execution of the branching instructions is time-consuming and inefficient. The addition of the conditional skip instruction to an assembly language's vocabulary allows processing systems to implement conditional branching functionality without significant reduction in processing speed or efficiency. Embodiments of the present invention will now be described in more detail.

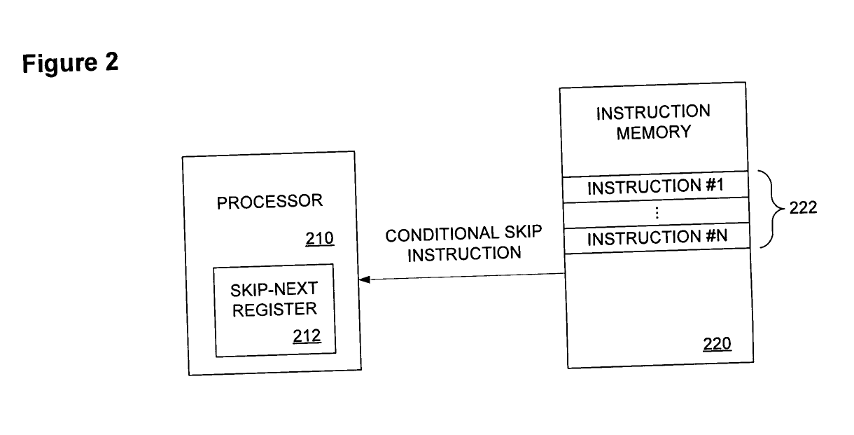

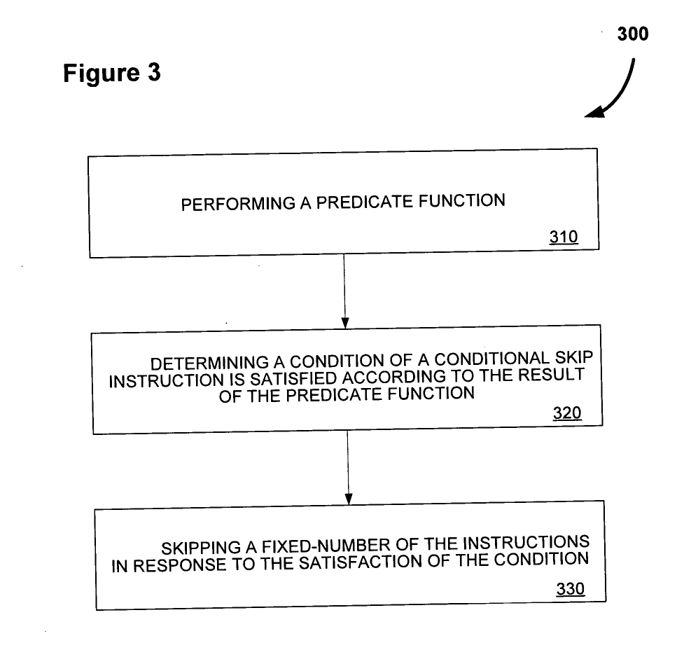

FIG. 2 illustrates, in block form, a processing system 200 useful with embodiments of the present invention. Referring to FIG. 2, the processing system 200 includes an instruction memory 220 populated with instructions 222. A processor 210 within processing system 200 may receive and execute the instructions 222 from the instruction memory 220. The instructions 222 may include one or more conditional skip instructions that are capable of execution by processor 210. The operation of processor 210 in response to an executed conditional skip instruction will be described in greater detail below with reference to FIGS. 3 and 4.

The processor 210 may include a skip-next register 212 to indicate results of skip instructions. When the skip instruction performs a comparison it sets the skip-next register and specifies whether or not the next instruction should be skipped. For instance, when an instruction directing the processor 210 to perform a skip instruction is executed, the processor 210 may set one or more bits within the condition register 212 to indicate the skip instruction results, e.g., “skip” or “don't skip”. The processor 210 may then use the skip-next register to either execute or to skip the next instruction. Although the conditional skip instructions are shown to conditionally skip the next instruction, in some embodiment the execution of the conditional skip instruction may prompt skipping of multiple instructions.

FIG. 3 shows an example flow chart 300 illustrating embodiments of a conditional skip instruction useful with embodiments of the present invention. According to a block 310, processor 210 performs a predicate function according to a conditional skip instruction. The processor 210 may set the results of the skip-next register. In some embodiments, the processor 210 may skip multiple instructions.

According to a next block 320, the processor 210 determines a condition of the conditional skip instruction is satisfied in response to the results of a predicate function performed at block 310. The processor 210 may determine the results according to the values set in the condition register 212, or directly from the performance of the predicate function.

According to a next block 330, the processor 210 skips a fixed-number of the instructions 222 in response to the satisfaction of the condition.

FIG. 4 shows an example operation of a conditional skip instruction useful with embodiments of the present invention. The assembly instructions shown in FIG. 4 implement the following if-statement:
if (A>B)
A=A+2;
Referring to FIG. 4, a memory 220 includes at least 3 address locations $0-$2 to be sequentially executed by processor 210. Execution begins at address location $0 with a conditional skip (skle) instruction. The skle instruction, when executed, directs the processor 210 perform the operation described above in flow chart 300 with reference to FIG. 3. In particular, the skle instruction performs a predicate comparing function to determine if data value A is greater than B. When data value A is greater than B, the skle instruction directs the processor 210 to skip over one instruction to address location $2. Otherwise, when A is greater than B, the execution continues to address location $1 where an addition (add) instruction adds 2 to data value A. The sequential execution then reaches address location $2 where the next instruction is awaiting execution. Although the condition of the conditional skip instruction shown in FIG. 4 is a “less than or equal to” condition, other conditions that may be implemented by the conditional instruction skip functionality. For instance, a similar result may be achieved with a conditional skip (skgt) instruction that skips instruction $1 when data value B is greater than A.

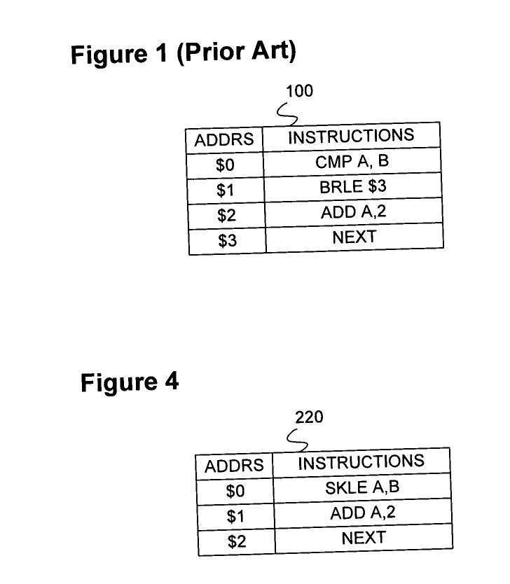

Both sets of instructions shown in FIGS. 1 and 4 implement the same if-statement, yet the set in FIG. 4 performed with less processing latency than the set in FIG. 1. This decrease in processing time is achieved with a conditional skip instruction that fixes the length of the skip, in this case to one instruction, thus eliminating the branch required by conditional branching instructions.

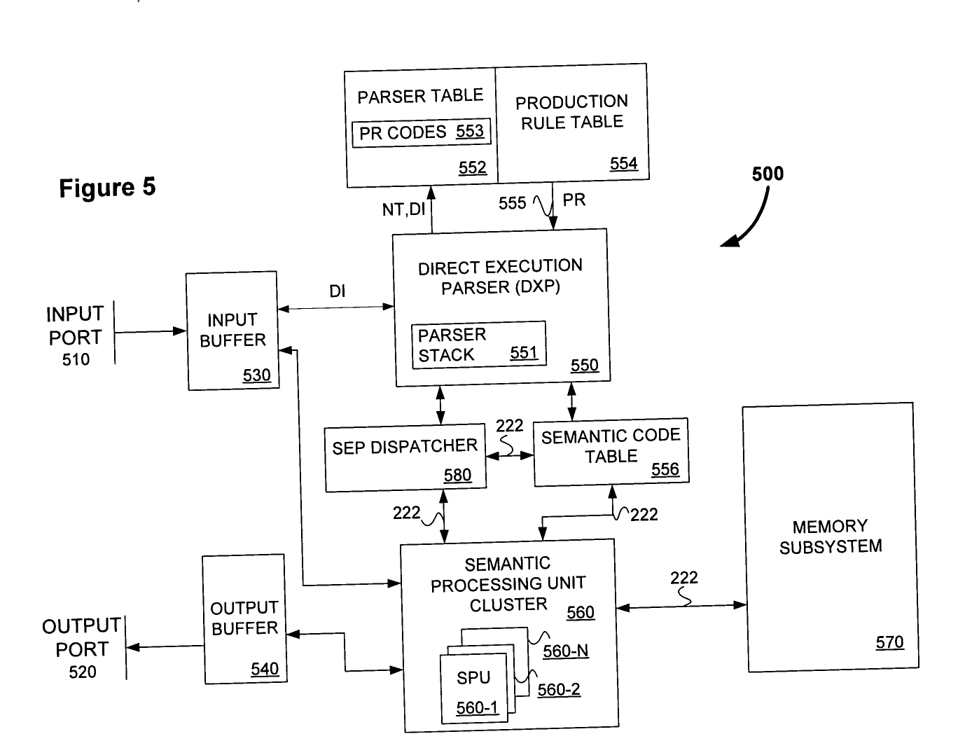

FIG. 5 illustrates, in block form, a reconfigurable semantic processor 500 useful with embodiments of the processing system 200 shown in FIG. 2. Referring to FIG. 5, the reconfigurable semantic processor 500 contains an input buffer 530 for buffering data streams received through the input port 510, and an output buffer 540 for buffering data steams to be transmitted through output port 520. Input 510 and output port 520 may comprise a physical interface to network 120, e.g., an optical, electrical, or radio frequency driver/receiver pair for an Ethernet, Fibre Channel, 802.11x, Universal Serial Bus, Firewire, SONET, or other physical layer interface. A platform implementing at least one reconfigurable semantic processor 500 may be, e.g., PDA, Cell Phone, Router, Access Point, Client, or any wireless device, etc., that receives packets or other data streams over a wireless interface such as cellular, CDMA, TDMA, 802.11, Bluetooth, etc.

Semantic processor 500 includes a direct execution parser (DXP) 550 that controls the processing of packets in the input buffer 530 and a plurality of semantic processing units (SPUs) 560-1 to 560-N within a SPU cluster 560. Each of the SPUs 560-1 to 560-N is configured to process segments of the packets or for perform other operations. The semantic processor 500 includes a memory subsystem 570 for storing or augmenting segments of the packets.

The DXP 550 maintains an internal parser stack 551 of non-terminal (and possibly also terminal) symbols, based on parsing of the current input frame or packet up to the current input symbol. When the symbol (or symbols) at the top of the parser stack 551 is a terminal symbol, DXP 550 compares data DI at the head of the input stream to the terminal symbol and expects a match in order to continue. When the symbol at the top of the parser stack 551 is a non-terminal (NT) symbol, DXP 550 uses the non-terminal symbol NT and current input data DI to expand the grammar production on the stack 551. As parsing continues, DXP 550 instructs one or more of the SPUs 560-1 to 560-N to process segments of the input, or perform other operations.

Semantic processor 500 uses at least three tables. Code segments 222 for SPUs 560-1 to 560-N, including at least one conditional skip instruction, are stored in semantic code table 556. Complex grammatical production rules are stored in a production rule table (PRT) 554. Production rule (PR) codes 553 for retrieving those production rules are stored in a parser table (PT) 552. The PR codes 553 in parser table 552 also allow DXP 550 to detect whether, for a given production rule, a code segment from semantic code table 556 should be loaded and executed by one of the SPUs 560-1 to 560-N. In some embodiments, code segments 222 many be stored within memory subsystem 570, and retrieved by SPUs 560-1 to 560-N according to production rules 555 from the PRT 554.

The production rule (PR) codes 553 in parser table 552 point to production rules in production rule table 554. PR are stored, e.g., in a row-column format or a content-addressable format. In a row-column format, the rows of the table are indexed by a non-terminal symbol NT on the top of the internal parser stack 551, and the columns of the table are indexed by an input data value (or values) DI at the head of the input. In a content-addressable format, a concatenation of the non-terminal symbol NT and the input data value (or values) DI can provide the input to the parser table 552. Preferably, semantic processor 500 implements a content-addressable format, where DXP 550 concatenates the non-terminal symbol NT with 8 bytes of current input data DI to provide the input to the parser table 552. Optionally, parser table 552 concatenates the non-terminal symbol NT and 8 bytes of current input data DI received from DXP 550.

The semantic processor 500 includes a SPU entry point (SEP) dispatcher 580 to allocate one or more of the SPUs 560-1 to 560-N for executing the code segments 222 from semantic code table 556 according to production rules 555 retrieved by the DXP 550. The SEP dispatcher 580 may load allocated SPUs 560-1 to 560-N with code segments 222 from semantic code table 556, or provide the SPUs 560-1 to 560-N one or more addresses to the code segments 222 within the semantic code 556. The SPUs 560-1 to 560-N may then directly load the code segments 222 corresponding the addresses provided by the SEP dispatcher 580.

Once loaded, the code segments 222 may cause one or more SPUs 560-1 to 560-N to perform a conditional instruction skip. Using the example shown in FIG. 4, one of the SPUs, e.g., 560-1, may execute a skle instruction that directs the SPU 560-1 to skip over the add instruction when data value A is less than or equal to data value B. Otherwise, the SPU 560-1 executes the add instruction prompting the SPU 560-1 to add 2 the data value A. The SPU 560-1 may have retrieved data values A and B from the memory subsystem 570 or the input buffer 530 in response to previously executed code segments 222.

One skilled in the art will recognize that the concepts taught herein can be tailored to a particular application in many other advantageous ways. In particular, those skilled in the art will recognize that the illustrated embodiments are but one of many alternative implementations that will become apparent upon reading this disclosure.

The preceding embodiments are exemplary. Although the specification may refer to an “one”, “another”, or “some” embodiment(s) in several locations, this does not necessarily mean that each such reference is to the same embodiment(s), or that the feature only applies to a single embodiment.

What is claimed is:

1. A method for executing instructions comprising:
identifying a conditional skip instruction;
determining when a conditional skip instruction is satisfied according to a result of an associated comparison function; and
skipping a fixed-number of the instructions defined by the conditional skip instruction when the conditional skip function is satisfied.

2. The method of claim 1 including performing the compare function in response to executing the conditional skip instruction.

3. The method of claim 2 wherein the result of the compare function includes a Boolean value that indicates when the next instruction or instructions should be skipped.

4. The method of claim 1 including
comparing two data values in the compare function in response to executing the conditional skip instruction; and
setting a skip-next register according to a result of the comparison.

5. The method of claim 4 including determining when the conditional skip instruction is satisfied according to the skip-next register.

6. The method of claim 4 including setting a bit in the skip-next register when one of the data values satisfies the comparison function to another data value.

7. The method of claim 1 including automatically skipping one instruction when the conditional skip instruction is satisfied.

8. The method of claim 1 including
determining the conditional skip instruction is not satisfied according to the result of the predicate function; and
executing a next instruction when the conditional skip instruction is not satisfied.

9. A system comprising:
a semantic code table populated with instructions including at least one conditional skip instruction; and
a semantic processing unit configured to skip a fixed-number of instructions according to the conditional skip instruction.

10. The system of claim 9 including a direct execution parser causing the semantic processing unit to execute one or more conditional skip instructions stored within the semantic code table.

11. The system of claim 9 including a plurality of semantic processing units, each configured to execute conditional skip instructions from the semantic code table.

12. The system of claim 11 including a dispatcher configured to provide at least one conditional skip instruction from the semantic code table to the semantic processing units.

13. The system of claim 9 wherein the semantic processing unit skips one instruction according to the conditional skip instruction.
